(19) United States
(12) Patent Application Publication
(10) Pub. No.: US 2015/0085114 A1
(43) Pub. Date: Mar. 26, 2015

(54) Method for Displaying Video Data on a Personal Device

(71) Applicant: OBSHESTVO S OGRANICHENNOY OTVETSTVENNOSTYU SINEZIS, Moscow (RU)

(72) Inventor: Nikolay Vadimovich Ptitsyn, Moscow (RU)

(21) Appl. No.: 14/382,003

(22) PCT Filed: Apr. 17, 2013
(86) PCT No.: PCT/RU2013/000326

§ 371 Date: Aug. 29, 2014

(30) Foreign Application Priority Data
May 15, 2012 (RU) 2012119843

(51) Int. Cl. H04N 7/18; G06K 9/46; H04N 5/232

(52) U.S. Cl. CPC H04N 7/183; H04N 5/23293; G06K 9/4604
USPC 348/143

(57) ABSTRACT

This invention relates to the sphere of data-processing and data-displaying methods. A method for displaying video data on a personal device comprising the following steps: (a) receiving at least one video frame from at least one video source; (b) receiving at least one bounding box corresponding to the location of an alarm object and/or event on the video frame; (c) extracting from the video frame an image portion containing the alarm object and/or event in accordance with the corresponding bounding box; (d) rescaling and/or cropping the extracted image portion (the thumbnail) to fit the target thumbnail size; (e) displaying at least one thumbnail on the personal device screen.

The invention improves the capacity of the graphic user interface of the personal device to be used for identifying the alarm object and reduces the communication-channel load.

### TECHNICAL FIELD

The invention relates to data processing—namely, closed-circuit security television (CCTV), video surveillance, and video analytics. The invention ensures the clear display of events captured by a video-surveillance system as well as the clear display of the results of an event search in the video-surveillance archives. The display is on the screen of a personal device, such as a mobile phone, touchpad, or tablet PC. The invention reduces the costs of video-data analysis, transfer, and storage, and it enhances the scope of applying video surveillance as a service (VSaaS).

### PRIOR ART

One of the trends in the development of video-surveillance systems is the design of applications, or software, for personal devices like smart phones and touchpads. Such applications enable a remote user to view live and archived (recorded) video from video-surveillance cameras and also to receive prompt notifications of alarm situations automatically detected by video analytics.

Unlike applications for workstations connected to video-surveillance systems via a local network, such personal-device applications have a number of constraints: a) a small screen, b) limited channel bandwidth, c) a weaker processor, and d) less memory.

These constraints prevent the user from operating an efficient remote video-surveillance system, especially when applying high-definition (HD) cameras with large frame size and data flow.

As a rule, designers of video-surveillance systems solve this problem by increasing the video-compression ratio, including reducing both the size and the rate of transmission of the frames transmitted from the video-surveillance system to the personal device. This approach does not exploit the full potential of HD cameras, and it considerably limits remote users' ability to distinguish distant objects and the details of those objects in the kinds of ways that are required to identify the objects on the personal device.

Standard video-compression algorithms—for example, H.264—use interframe compression to eliminate redundant data flow during fixed-background transmission. At best, only moving-object images are transmitted against a fixed background. However, a substantial amount of redundant data is in fact transferred because of the changing environment and camera noise. Standard video-compression algorithms fail to efficiently single out valuable information, like moving people, against the background noise, such as rain, rustling leaves and grass, reflections in water, and wet asphalt surfaces.

In general, alarm analysis on a mobile video is challenging for a remote user. It requires a high-speed Internet connection, and it takes time to download and to view the videos. Unlike operators of command-and-control centres (situation centres), who are focused on their monitors, a mobile user may not have enough time to view the video. A mobile user may benefit from fast downloading and viewing a still image of the alarm.

Some current mobile applications display a single-piece frame generated by the motion detector or video analytics. This approach has certain disadvantages.

First, frame reduction for personal devices omits image detail; this lack of detail makes it difficult for the user to notice and/or to identify the object. A detailed analysis requires scrolling the image, which is impractical for a mobile user.

Second, all alarm frames from one camera look alike when displayed as a list or thumbnail table; this similarity makes it difficult for the user to correlate the frames with objects or events (FIG. 3, left). Full thumbnail frames can be used only to define the camera from which the frames originated.

To solve the problem of poor frame details, some existing video-surveillance systems use the “picture in picture” (PIP) function; they transmit an additional video stream with a higher resolution for the window frame in which motion is detected (“Auto Digital Zoom”). This approach allows getting a full-frame video with a basic level of detail along with extra, more-detailed videos for windows focused on one selected object.

One of the major differences between the invention and common approach is that, in this invention personal devices display not a video stream but static alarm thumbnails. To view detailed images of an alarm object or a corresponding video, the user selects the relevant thumbnail.

This invention has the following advantages in comparison with its current counterparts: a) maximum detail of the alarm image with minimal communication-channel load, as a single-piece frame or a sequence is transmitted to a personal device only at the user's request; and b) alarm thumbnails differ considerably from other thumbnails; this difference in appearance makes it more convenient for the user to navigate the list or table of thumbnails.

### SUMMARY OF THE INVENTION

A video-surveillance system with an option for mobile video-data transmission typically comprises cameras, a local server, the central server, and a personal device (FIG. 2). Certain “smart” cameras can function as a local server and therefore can substitute for it. Some personal devices support direct connection to a local server or a camera, but this option limits the functionality of the video-surveillance system.

A method for displaying video data on a personal device comprising the following steps:
a. receiving at least one video frame from at least one video source
b. receiving at least one bounding box corresponding to the location of an alarm object and/or event on the video frame
c. extracting from the video frame an image portion containing the alarm object and/or event in accordance with the corresponding bounding box
d. rescaling and/or cropping the extracted image portion (the thumbnail) to fit the target thumbnail size
e. displaying at least one thumbnail on the personal device screen

The bounding box for the alarm object can be set by means of video analytics and/or a motion detector outside the personal device—for instance, in a camera or in a local or central server.

The bounding box for the alarm object can be set using optimal-angle-selection algorithms that meet the following criteria: the largest visible size of the object, the best contrast of the object with its background, the object positioned in a specified frame zone, and maximum correlation of the object with a predefined template (pattern).

A video fragment can be singled out using a bounding box in various components of the video-surveillance system, including personal devices, cameras, and local or central servers.

A thumbnail can be formed in various components of the video-surveillance system, including personal devices, cameras, and local or central servers.

The bounding box can be rectangular, can follow the object shape, or can be polygonal or circular.

Thumbnails can be displayed as a list and/or as a mosaic table with extra text information about the alarm object and/or event.

Thumbnails can be displayed over the map and/or plan of the area monitored by the video-surveillance system.

Thumbnails can be displayed over alarm frames in the locations of the corresponding alarms.

Thumbnails can be sorted and/or filtered by various criteria, including date, time, event type, situation type, camera involved, and/or priority (degree of importance).

The size of thumbnails can be set (zoomed in or out) by the user.

The size of thumbnails can be determined automatically, depending on the screen size and/or on the number of thumbnails.

The size of thumbnails can depend on the initial size of the object in the alarm frame or on priority (degree of importance of the object and/or event).

Fixed thumbnail size can match the size of the image fragment.

A thumbnail may be correlated with a single-piece frame, a frame fragment, and/or a sequence of frames viewable by the user.

A thumbnail, a single-piece frame, a frame fragment, and/or a sequence of frames can be stored in the personal device to be viewed in offline mode.

A thumbnail, a single-piece frame, a frame fragment, and/or a sequence of frames can be transmitted to a personal device using push technology or user request.

A thumbnail object can be a person, a person's face, an animal, a vehicle, or a vehicle license plate.

A thumbnail may contain the object path in the frame or in the map.

Thumbnails can be applied by users of a video-surveillance system as a means of visual identification of the object and/or event.

### BRIEF DESCRIPTION OF DRAWINGS

FIG. 1. Thumbnail generation of an alarm object by the mobile video data-displaying method.

FIG. 2. Sample of a video-surveillance system implementing the mobile video data-displaying method.

FIG. 3. The current (left) and the new (right) mobile video data-displaying methods compared on the iPhone personal device.

FIG. 4. Frame thumbnails of alarm objects (events) displayed over a map or a plan.

FIG. 5. Several alarm fragments merged on a single frame to display the object's motion on a personal device.

### DETAILED DESCRIPTION

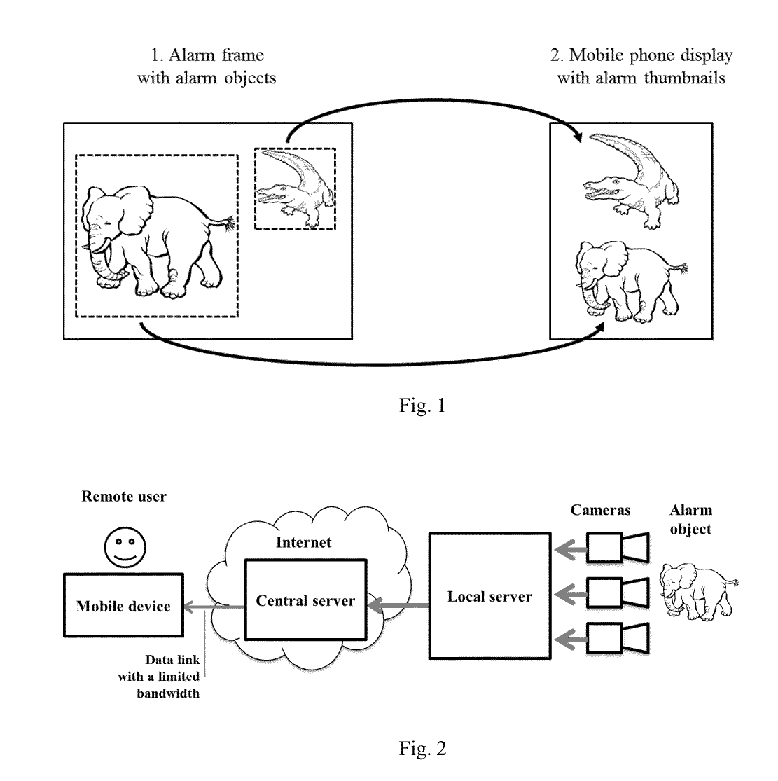

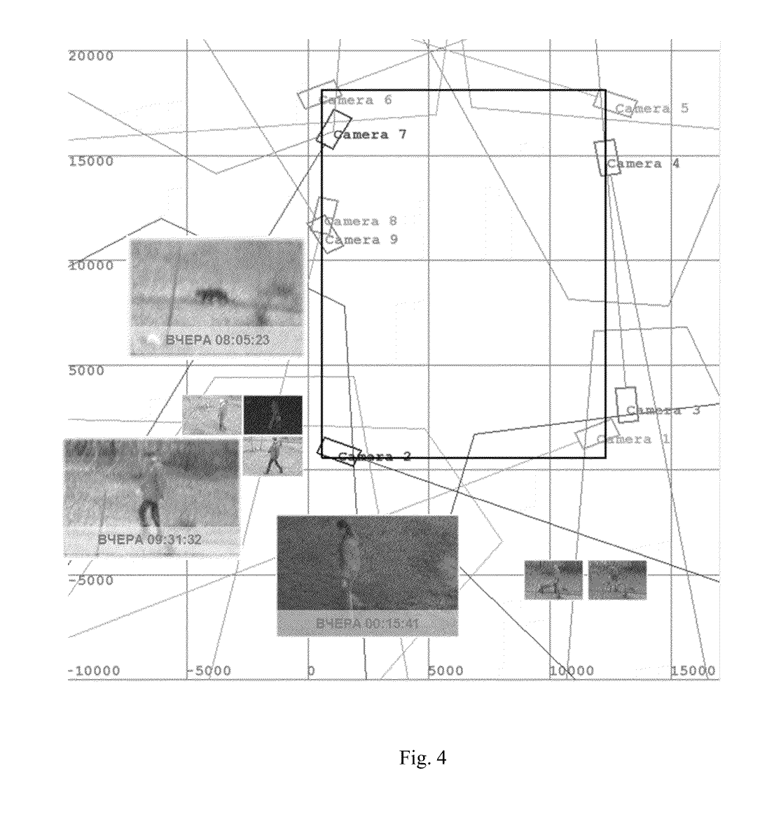

Embodiments of the present invention are described herein with reference to FIGS. 1-5.

Displaying video data on a personal device involves the following steps.

Step 1. Receiving an Alarm Frame from the Video Camera

During Step 1 the original data—namely, a sequence of frames—is received to further single out the object and display it on the personal device. Video cameras of any type—for example, network or analogue—can be used. The frame sequence is transmitted to the local server or directly to the central server (FIG. 2).

The greatest effect of the current invention is achieved when working with HD cameras in cases where the frame size, measured in pixels, exceeds the size of the objects captured.

Step 2. Detecting an Alarm Object

During Step 2, alarms are singled out of the frame sequence using motion detection or video analytics built into the camera, a local server, or the central server. Automated object detection, tracking, and classification, as well as automatic detection of situations under given rules, are implemented with the help of popular video-analytics algorithms.

Alarm objects include people, faces, animals, vehicles, vehicle license plate, smoke, and fire. Alarm objects may correspond to alarm situations, such as an object approaching a given area, an object crossing a tripwire, or a fire breaking out. Each alarm situation is correlated with at least one alarm object.

The efficiency of this video data-displaying method to a large extent depends on the accuracy of the video analytics—namely, the accuracy of singling out alarms. Obtaining a high frequency of false positives or missed objects when applying this invention may be inappropriate.

Step 3. Determining Frames and Bounding Boxes for Alarm Objects with the Appropriate Monitoring Angle

Step 3 singles out frames of the sequence received and also singles out bounding boxes on the frames; this procedure limits the alarm objects that are to be displayed as fixed mobile thumbnails to those objects having the optimal angle of view for such display (FIG. 1). Well-known object-tracking algorithms are used, including multitracking algorithms. Tracking involves continuous analysis of the tracked-object characteristics. The optimum angle can be selected according to various criteria such as: a) the largest visible size of the object, b) the best contrast of the object contrast of the object with its background, c) the object positioned in a given frame zone, and d) the maximum correlation of the object and the object image with a predefined object template (pattern).

For each alarm object detected, Step 3 results in at least one rectangular bounding box corresponding to a frame fragment with the optimal-angle image of the alarm object singled out of the frame sequence.

Multicamera object-tracking algorithms allow switching from camera to camera, thus reducing the number of events correlated with one and the same alarm object and displayed on a personal device.

Step 4. Singling out Frame Fragments Containing Alarm Objects

During Step 4 each alarm object has its own fragments following the rectangular bounding boxes singled out of the frame as individual images.

If the selection is performed by means (e.g. software) within the camera or by the server, the communication-channel load between the server and the personal device is reduced.

If the selection is made by the personal device, the communication-channel load increases, but the mobile user has an opportunity to review the entire frame.

A fragment can be singled out by taking into account the mobile screen proportions for optimum display of thumbnails.

Step 5. Generating Thumbnails

During Step 5 each alarm object has its thumbnail generated by scaling the fragment specified up or down to the given size for display on a mobile phone (FIG. 1).

The thumbnail size can be set by the user; in particular, it can be scaled up or down at the user's request.

The size of thumbnails can be determined automatically, depending on the screen size and/or the number of thumbnails.

If scaling is performed by means (e.g. software) within the camera or the server, the load on the communication channel between the server and the personal device is reduced for large objects (in the foreground of the camera) and increases for small objects (in the background of the camera).

If scaling is performed by the personal device, the user can dynamically change the scale of the thumbnail.

Step 6. Displaying thumbnails

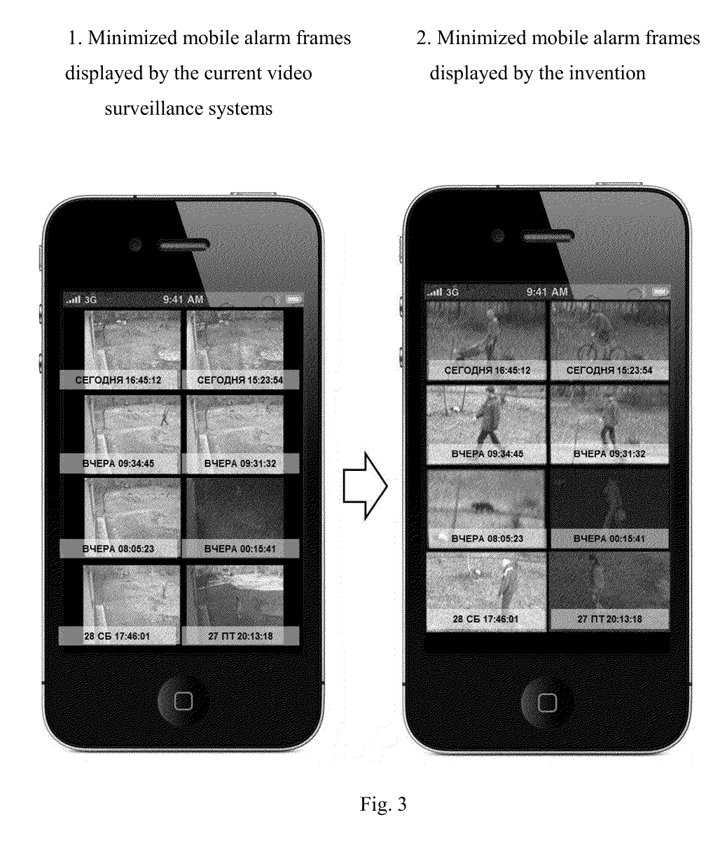

During Step 5 the acquired thumbnail is displayed on a mobile phone. FIG. 3 shows thumbnails displayed as a list or a table with extra text information about the alarm object and/or event. The left side of FIG. 3 shows the existing video data-displaying methods applied without the current invention. The right side of Figure Fig. illustrates the way the invention is applied. The invention proves to considerably enhance the quality of the image displayed to the mobile user because of the automatic alarm-object scaling and selection from frame sequences.

Figure Fig. demonstrates the invention applied to display the thumbnails over a map or plan of the monitored area.

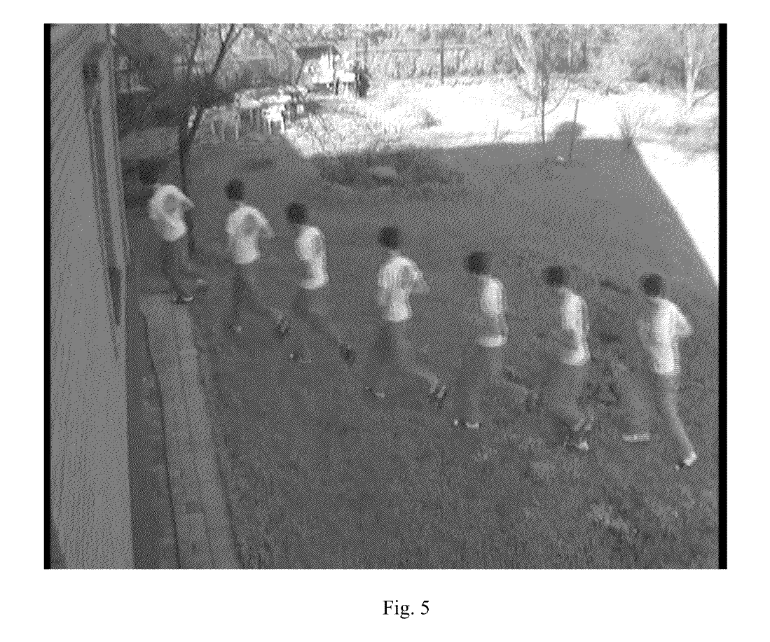

FIG. 5 illustrates several frame fragments with one and the same object merged into a single frame in order to display the alarm-object motion on a personal device.

Steps 1-5 of video data processing can be performed by software embedded in a camera, a local server, or the central server; steps 4 and 5 can also be performed by software embedded in the personal device.

This video data-displaying method can be used not only on a personal device but on a desktop as well. In particular, the alarm-object thumbnails can be displayed either in an Internet browser or by using special software.

This video data-displaying method can be applied not only to live video (continuous video flow) coming from the camera but also to archived video recorded into storage (postprocessing).

The video data-displaying method can be applied to video-surveillance systems based on standards and/or guidelines adopted by the Open Network Video Interface Forum (ONVIF, www.onvif.org) or the Physical Security Interoperability Alliance (PSIA, psialliance.org). In particular, thumbnails, alarm-frame fragments, separate alarm frames, and frame (video) sequences can be transmitted according to ONVIF and/or PSIA standards.

Thumbnails, alarm-frame fragments, and separate alarm frames can be transmitted in JPEG or JPEG2000 formats.

1. A method for displaying video data on a personal device comprising the following steps:
a. receiving at least one video frame from at least one video source;
b. receiving at least one bounding box corresponding to the location of an alarm object and/or event on the video frame;
c. extracting from the video frame an image portion containing the alarm object and/or event in accordance with the corresponding bounding box;
d. rescaling and/or cropping the extracted image portion to fit the target thumbnail size;
e. displaying at least one thumbnail on the personal device screen.

2. The method as recited in claim 1, wherein the bounding box for the alarm object is determined by means of video analytics and/or by a motion detector located outside the personal device, a motion detector embedded in the camera and local or central servers including.

3. The method as recited in claim 1, wherein the thumbnail frame and the bounding box are determined using a video-processing algorithm based on one or more of the following thumbnail-selection criteria:
the largest visible size of the object,
the best contrast of the object image with the object's background,
the object location in a predefined region of the video frame,
the maximum correlation of the object image correlation of the image with a predefined object template.

4. The method as recited in claim 1, wherein the image portion containing the alarm object and/or event is extracted from the video frame located outside the personal device by a component of the video-surveillance system such as a camera or a local or central server.

5. The method as recited in claim 1, wherein the image portion is rescaled to fit the thumbnail list outside the personal device by a component of the video-surveillance system such as a camera or a local or central server.

6. The method as recited in claim 1, wherein other shape types, such as rectangular, polygonal, or circular shapes, are used instead of the bounding box to extract the image portion containing the alarm object and/or event from the video frame.

7. The method as recited in claim 1, wherein at least two thumbnails are displayed as a list or a mosaic.

8. The method as recited in claim 1, wherein at least one thumbnail is displayed over a map or plan of the area monitored by the video-surveillance system.

9. The method as recited in claim 1, wherein at least one thumbnail is displayed over the full video frame in accordance with the object locations.

10. The method as recited in claim 1, wherein thumbnails are sorted and/or filtered by all or a part of the following criteria:
date;
time;
type of event;
type of situation;
camera;
priority.

11. The method as recited in claim 1, wherein the size of thumbnails is set by the user.

12. The method as recited in claim 1, wherein the thumbnails can be scaled up or down at the user's request.

13. The method as recited in claim 1, wherein the size of the thumbnail is determined automatically, depending on the screen size and/or the number of thumbnails.

14. The method as recited in claim 1, wherein the size of the thumbnails depends on the initial size of the alarm object or its priority.

15. The method as recited in claim 1, wherein the thumbnail size is the same as the original size of the video-frame portion.

16. The method as recited in claim 1, wherein the user can zoom in the video-frame portion or the full-video frame.

17. The method as recited in claim 1, the user can play the video itself by clicking or touching the thumbnail.

18. The method as recited in claim 1, wherein the thumbnail and/or video frames are stored on a personal device to be viewed in offline mode.

19. The method as recited in claim 1, wherein the thumbnail and/or video frames are transmitted to a personal device using push technology.

20. The method as recited in claim 1, wherein the thumbnail and/or video frames are transmitted to a personal device at the user's request.

21. The method as recited in claim 1, wherein the alarm object is one of the following:
a person;
a person's face;
an animal;
a vehicle;
a vehicle number plate.

22. The method as recited in claim 1, wherein the thumbnail comprises the alarm-object trajectory.

23. The method as recited in claim 1, wherein the thumbnail is used to perform visual identification of the object and/or event in the video-surveillance system.
